(19) United States
(12) Patent Application Publication
(10) Pub. No.: US 2010/0250236 A1
(43) Pub. Date: Sep. 30, 2010

(54) COMPUTER-ASSISTED ABSTRACTION OF DATA AND DOCUMENT CODING

(75) Inventors: Vasudevan Jagannathan, Morgantown, WV (US); Henry Ware, Morgantown, WV (US); Sandy J. Leonard, Pilesgrove, NJ (US); Brian Ellenberger, Woodstock, GA (US)

Correspondence Address: BUCHANAN, INGERSOLL & ROONEY PC, POST OFFICE BOX 1404, ALEXANDRIA, VA, 22313-1404, US

(73) Assignee: MEDQUIST IP, LLC, Mt. Laurel, NJ (US)

(21) Appl. No.: 12/752,043

(22) Filed: Mar. 31, 2010

Related U.S. Application Data
(60) Provisional application No. 61/165,296, filed on Mar. 31, 2009.
(60) Provisional application No. 61/248,091, filed on Oct. 2, 2009.

(51) Int. Cl. G06F 17/27; G10L 15/04

(52) U.S. Cl. 704/9; 704/251

(57) ABSTRACT

A computer-assisted method of abstracting and coding data includes receiving one or more documents is disclosed. The methods and systems extract information from a record based on extraction rules that correspond to an identified record type, determine codes corresponding to the information extracted from the record, present the correspondence between the extracted information and the codes, receive from the user-input device a validation of the correspondence between the extracted information and one of the codes, and output a report including the validated information and the validated code.

This application claims benefit of priority to U.S. Provisional Patent Application numbers 61/165,296, filed on Mar. 31, 2009, and 61/248,091 filed Oct. 2, 2009. The disclosures of both Application numbers 61/165,296 and Application numbers 61/248,091 are both hereby incorporated into this specification by reference in their entirety.

### FIELD

The present disclosure relates generally to computer-assisted abstraction and coding of information.

### BACKGROUND

Documents are frequently generated by transcribing dictated material. For instance, a user (e.g., a doctor) may speak information into a dictation device and provide the dictation to a transcription service which converts the dictation into a text document. In some cases, specific information may be “abstracted” from the document. For example, in healthcare applications, the transcription service may abstract the document by extracting a list of medications, allergies and/or quality measures that are included in the document. In addition, the service may associate medical codes with some or all of the extracted data. The extracted and coded information may be reviewed before being provided to an end-user such as an medical insurance provider. This process can be very time consuming and expensive.

### SUMMARY

Exemplary embodiments disclosed herein provide methods, systems and devices for computer-assisted abstracting and coding of information. The exemplary embodiments may extract information from a record based on extraction rules that correspond to an identified record type, determine codes corresponding to the information extracted from the record, present the correspondence between the extracted information and the codes, receive from the user-input device a validation of the correspondence between the extracted information and one of the codes, and output a report including the validated information and the validated code.

### BRIEF DESCRIPTION OF THE DRAWINGS

FIG. 1 is a block diagram illustrating an exemplary environment in which some embodiments may operate;

FIG. 2 is a flowchart illustrating an exemplary process; and

FIGS. 3A-5B illustrate exemplary graphical user interfaces.

### DETAILED DESCRIPTION

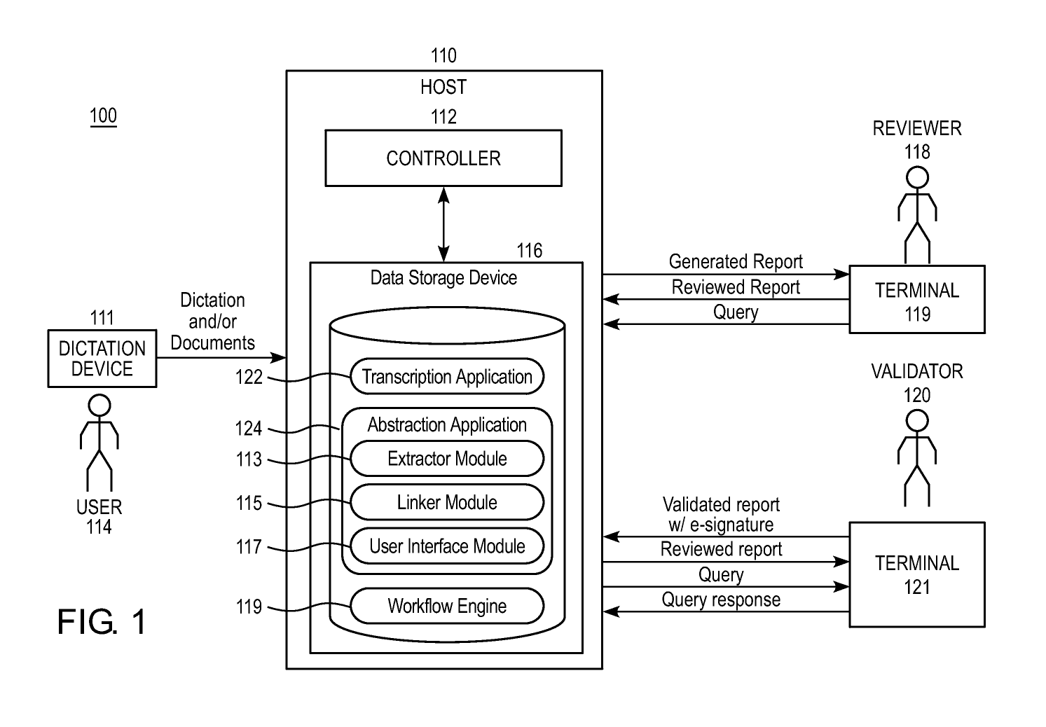

FIG. 1 is a block diagram illustrating an exemplary environment in which some embodiments may operate. As illustrated, environment 100 may include, a user 114, a dictation device 111, a host 110, a reviewer 118, a reviewer terminal 119, a validator 120 and a validator terminal 121.

User 114 can be any individual or entity that generates a document. For instance, user 114 can be an employee of a doctor's office, law firm or an insurance company who may desire to have dictation translated into text. Alternatively, user 114 may be a company, a hospital, a law firm an insurer or any other entity that generates documents.

Dictation device 111 can be any device for capturing information from user 114 such as a dictation machine, a telephone, a personal computer (e.g., desktop or laptop), a handheld recording device, a smart phone, or a personal digital assistant. Dictation device 111 also can be a special purpose device that allows user 114 to dictate, store and access audio/video files and documents for transmission to host 110.

Host 110 can be a device or system for receiving, storing, and/or processing documents received from user 114. The host can also be a device for providing information to reviewer 118 and validator 120. Host 110 can be implemented as one or more computer systems including, for example, a personal computer, a minicomputer, a microprocessor, a server, a workstation, a mainframe, or a similar computing platform.

Host 110 may be in communication with user 114, dictation device 111, reviewer 118, reviewer terminal 119, validator 120 and/or validator terminal 121 via one or more communication channels (not shown). The communication channels may be wired or wireless connections. In some instances, the communication channels can be a direct link such as an analog, a serial or a parallel interface. In other instances, the communication channels can be a shared, public, private, or peer-to-peer network, encompassing any wide or local area network such as an extranet, an intranet, the Internet, a Local Area Network (LAN), a Wide Area Network (WAN), a virtual private network (VPN), a voice over internet packet network (VoIP), a public switched telephone network (PSTN), an Integrated Services Digital Network (ISDN), or any other form of wired or wireless communication network.

Host 110 can include a controller 112 and data storage device 116. In addition, while not illustrated, controller 112 can include one or more processors, computer-readable memory (e.g., read-only memory and random access memory), in addition to other components such as a clock, a communication interface, a data bus, an input/output device, a user-input device and a display device.

Computer-readable data storage device 116 may include any hardware, software, firmware, or combination thereof that stores and retrieves information, including computer-readable program instructions and data. Data storage device 116 may be, for instance, a semiconductor, magnetic or optical-based information storage/retrieval device (e.g., flash memory, hard disk drive, CD-ROM, flash RAM). Although data storage device 116 is depicted as a single element, device 116 may comprise any additional number of storage media. Although controller 112 and data storage device 116 are shown as being within host 110, this location is merely exemplary. Controller 112 and data storage device 116 can be physically located inside or outside of host 110. For instance, data storage device 116 can be configured as a network accessible storage device located remotely from controller 112.

Reviewer 118 can be one or more individuals, software systems, computer systems, or a combination thereof for reviewing abstracted data for accuracy. Reviewer 118 can also include individuals who verify the accuracy of abstractions performed by individuals or computer programs that automatically perform the abstraction of data such as, coders, nurses, clinical document specialist and physicians. Only one reviewer 118 has been shown for illustrative purposes. However, environment 100 may include multiple reviewers of the same configuration.

Validator 120 can be one or more individuals, software systems, or a combination thereof for validating reviewed abstracted reports. In some cases, validator 120 performs quality control functions for a transcription service. In other cases, validator 120 may be an end user of the report, for instance, a doctor, nurse, coder, hospital administrator, lawyer or an insurance agent.

Terminals 119 and 121 can be data processing devices such as a remote terminal, personal computer or network workstation. Terminals 119 and 121 may include a processor, a data storage device and stored program instructions that control the terminals to receive and display information for reviewer 118 and validator 120. In some embodiments, terminals 119 an 121 may emulate the function of a terminal and allow concurrent use of local programs and access to a remote terminal host system.

Although user 114, dictation device 111, host 110, reviewers 118 and validator 120 are shown in FIG. 1 as separate elements, some or all of the elements can be combined or divided into fewer or greater number of elements at one or more locations. The particular division of functions is for illustration only, and different elements may perform one or more of the functions disclosed above.

As shown in FIG. 1, host 110 may store computer-executable instructions (e.g., software, firmware, applications, programs, code, portions of code, and combinations thereof) and data (e.g., data compilations, databases, data sets) in data storage device 116 that, when retrieved and executed by controller 112, control host 110 to transcribe, abstract and/or code documents, as disclosed herein. The computer-executable instructions can be encoded using any suitable computer programming language such as, C++, JAVA and the SCALA. SCALA is a programming language that supports both object-oriented computing and functional programming.

Data storage device 116 may include a transcription application 122, abstraction application 124 and a workflow engine 119. Although not shown, data storage device 116 may include other computer-executable instructions that control host 110 (e.g., a bootloader, an operating system, control modules and hardware drivers). In addition, data storage device 116 can store transcribed documents, patient data, rules, database of medical codes, abstractions, validated reports, documents, manually generated documents, clarification notes and private data. Data storage device 116 may also include a queue for storing reports of abstracted data awaiting review by reviewers 118.

Transcription application 122, when executed by controller 112, controls host 110 to transcribe documents received by the host. For instance, transcription application 122 may convert dictation and/or documents received from user 114 or dictation device 111 into text that is searchable and/or editable. In some cases, transcription application 122 may use voice recognition software to convert aural dictations into text. In other cases, transcription application 122 may use optical character recognition (OCR) software to convert documents into text. Alternatively or additionally, transcription application 122 may allocate the dictations or documents to human transcribers. In some instances, human transcribers verify the transcriptions performed by transcription application 122.

Abstraction application 124, when executed by controller 112, controls host 110 to extract information from the transcribed documents and generates corresponding codes for the extracted information. Abstraction application 124 includes an extractor module 113 for extracting information from documents, a linker module 115 for associating corresponding codes to the extracted data, and a user interface module 117 for presenting interactive graphic user interfaces.

Workflow engine 119, when executed by controller 112, controls host 110 to process workflow information. Workflow engine 119 may include multiple program modules for handling the workflow of data such as, a report generator process for generating a structured report of the extracted and coded data and presenting the structured report for end-user validation, a billing process for outputting data for billing and reimbursement, a quality measure process for outputting data for reporting quality measures, and an alert process for generating an alert when certain conditions are met.

FIG. 1 illustrates an exemplary information flow that may occur in some exemplary embodiments. For the sake of illustration, the example discussed below is directed to a system and/or service for transcribing patient information received from a medical provider. Of course, the disclosed embodiments are not limited to such examples and may be applied to other systems and services.

In one example, user 114 may be a physician that dictates a patient's information and diagnosis into a dictation device 111. Dictation device 111 may convert the physician's spoken words into electronic form and provide the dictation to host 110 over a communication channel. Dictation device 111 may provide the dictation to host 110 as a file (e.g., a single document), multiple files (e.g., multiple documents or portions of a document) or as a stream of information (e.g., streaming audio). Additionally or alternatively, the physician, through dictation device 111 may transmit documents to host 110. Documents may be papers (e.g., facsimiles) or computer-readable files (e.g., text, spreadsheets, images, datasets, multimedia, sound and/or video). For instance, when a patient is receiving care at a medical facility, many documents are generated related to the patient such as, progress notes, procedure lists, lab results, medical histories, physical examination reports, and consultation referrals. These documents can submitted to host 110 for concurrent abstraction and document review while the patient is receiving care at the medical facility.

Host 110 may receive dictations and/or documents related to a patient from the communication channel. The received dictation and/or documents may be stored in data storage device 116 for processing by transcription application 122 into dictation into a text document. As part of the exchange between user 114 and host 110, transcription application 122 can present an interactive user interface that provide instructions, warnings, and prompts to user 114 to enter information. For instance, transcription application 112 may prompt user 114 to dictate different types of information in different segments, as described in U.S. Pat. No. 7,383,183, the disclosure of which is incorporated herein by reference in its entirety.

The transcribed document, as well as any other documents received from dictation device 111 and/or user 113 may be submitted to abstraction application 124. The extractor module 113 analyzes each document to determine a corresponding document type. The document type indicates a category of a document based on identifying keywords in the document. For example, in the case of a patient's documents, keywords identifying a document type can be “discharge summary,” “history and physical consultation,” “laboratory results,” “admission” and the like. The keyword “discharge summary” would identify the document type as a discharge summary.

Based on abstraction rules stored in storage device 116 that correspond to the document types, extractor module 113 may extract specific data. The abstraction rules are a plurality of rule sets which specify the data to extract from a particular type of document.

The extractor module 113 may identify a document type and extracts data from the document corresponding to the data specified by one or more rules using natural language processing (NLP). Often, clinical information generated by physician dictation is stored as free text in a transcribed document. Natural language processing allows for the conversion of the free text data into a computer-readable format so that the data may be used by other programs to automate applications. For example, prior to data extraction, a NLP engine using a dictionary look-up approach can be used to normalize the document into a standard format (e.g., formatting section title headers of the document with logical observation identifiers names and codes).

Extractor module 113 includes NLP extractors, which are specific engines focused on extracting content from different types of documents. Any of a variety of natural language processing techniques can be employed to perform the extractions. In some embodiments, a “bag of words” methodology can be used. An example of this methodology that is suitable for use in the disclosed embodiments is described in “Natural Language Processing Framework to Assess Clinical Conditions”, published in the Journal of American Medical Informatics Association, Volume 16, Number 4, July/August 2009, written by Ware et al., the content of which is incorporated by reference herein in its entirety.

Linker module 115, when executed by controller 112, controls host 110 to determines corresponding codes for all or part of the extracted information. Linker module 115 determines the corresponding codes using natural language processing. NLP linkers are engines focused on evaluating extracted information to determine a corresponding medical code. The codes may correspond to an industry standard coding system such as, SNOMED (systemized nomenclature of medicine), RxNorm, ICD 9, and LOINC (logical observation identifiers names and codes). The NLP linkers can use any natural language processing technique for coding information such as, regular expression (Regex) pattern matching and context evaluation.

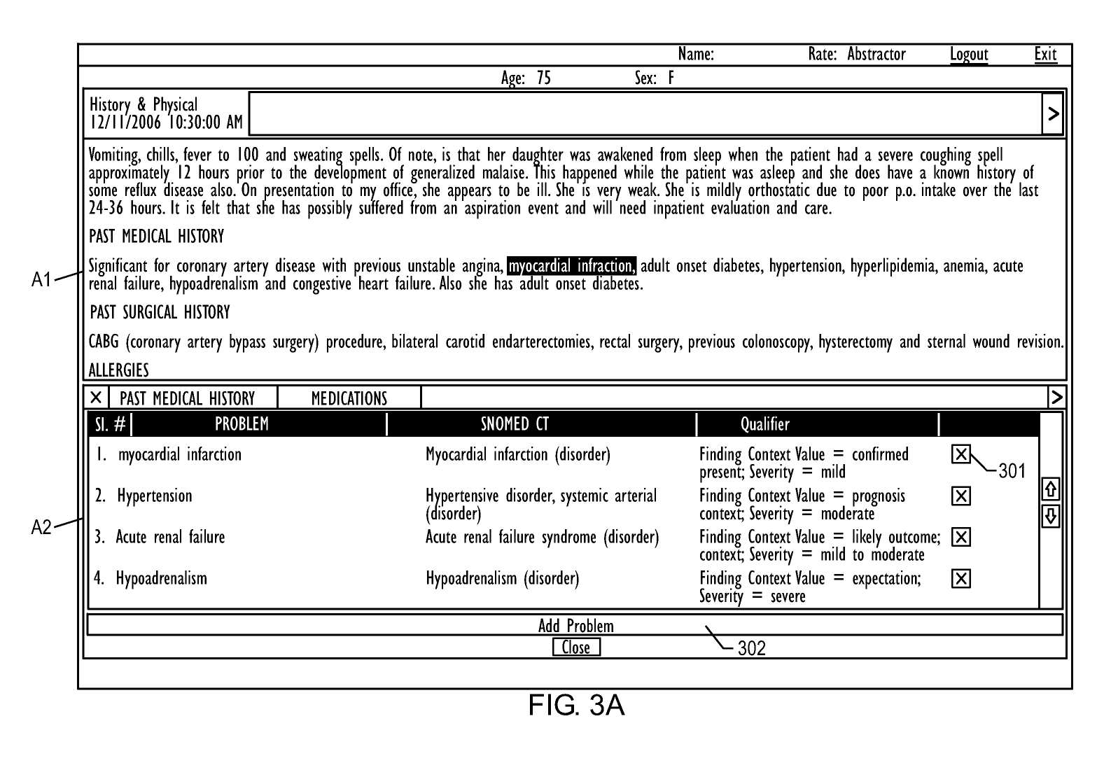

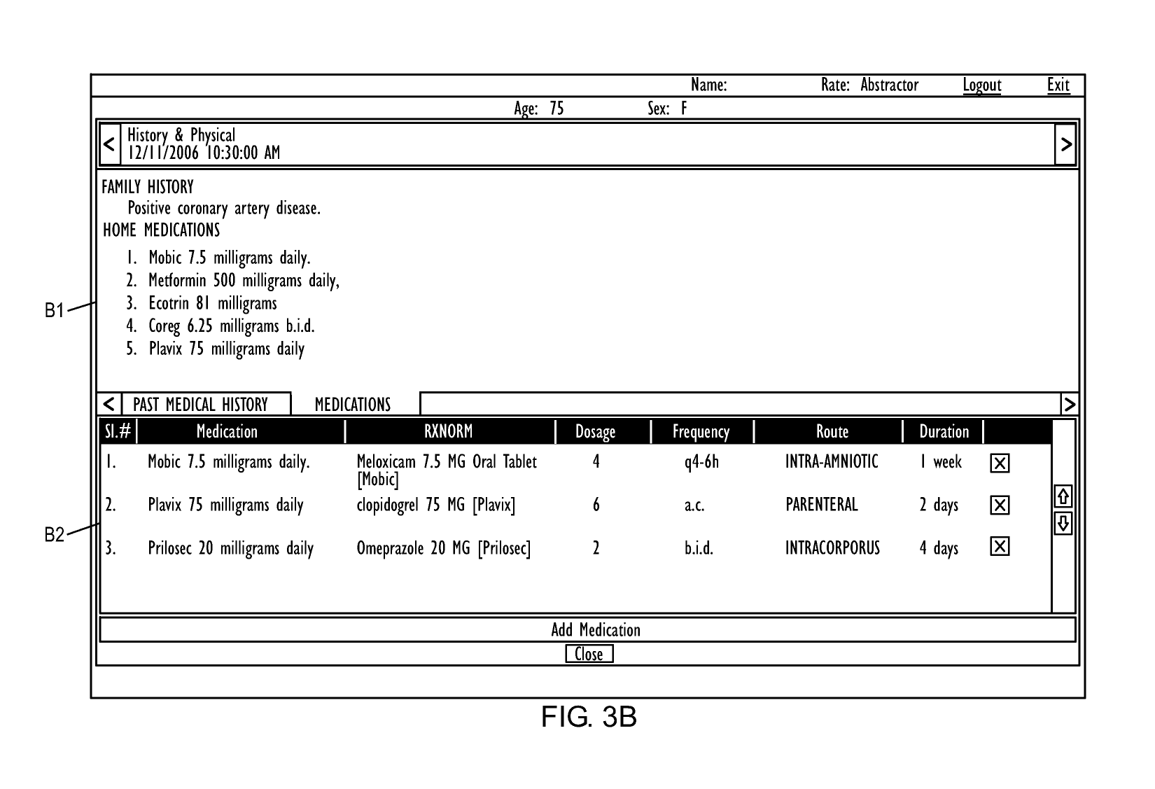

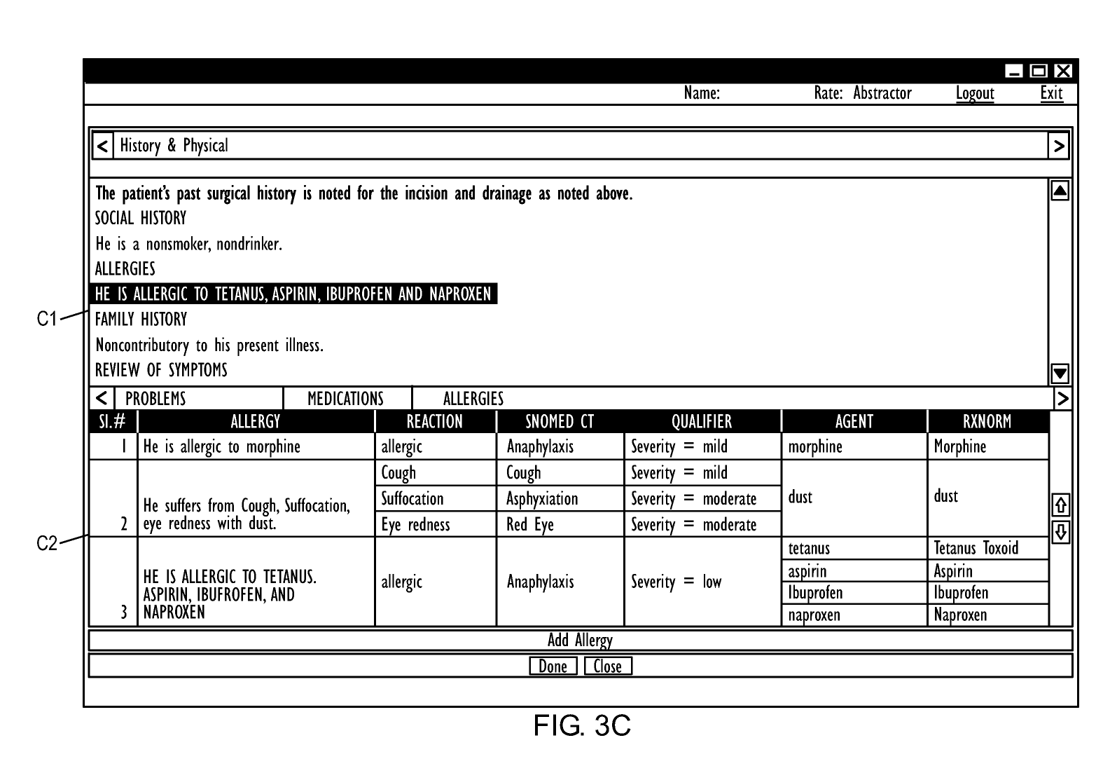

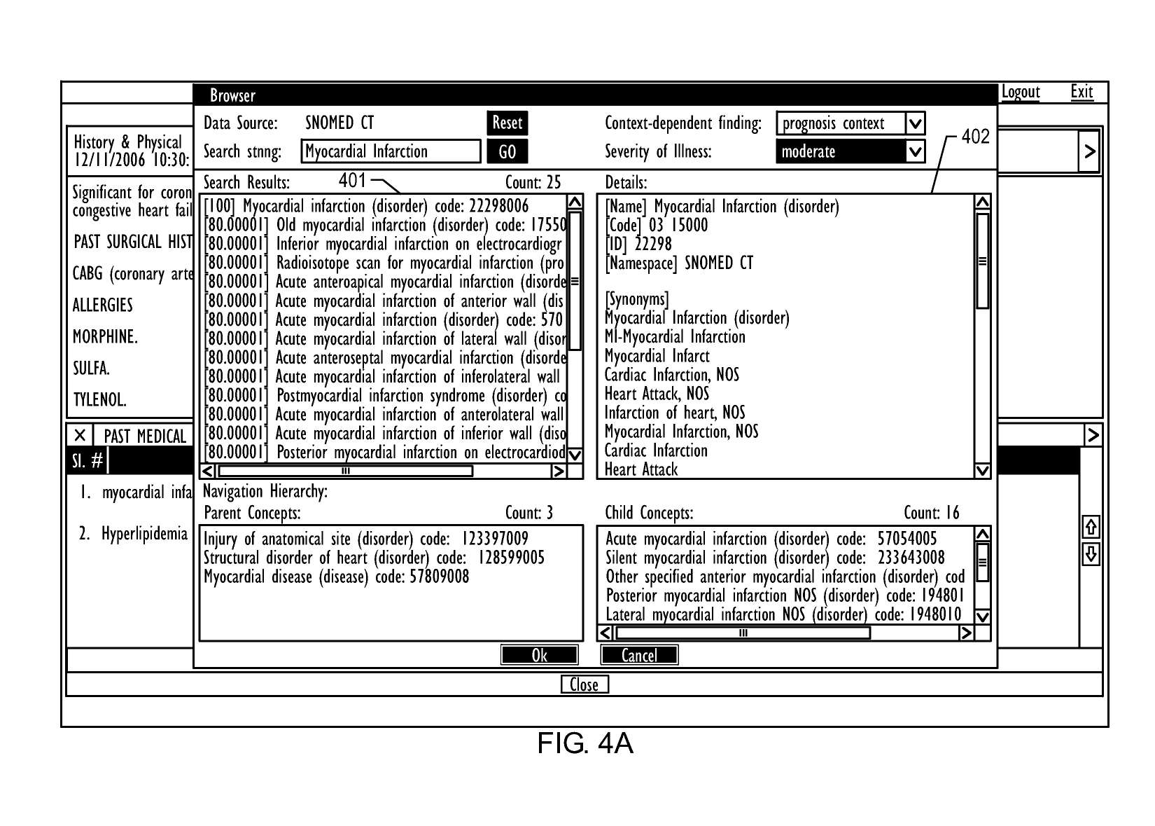

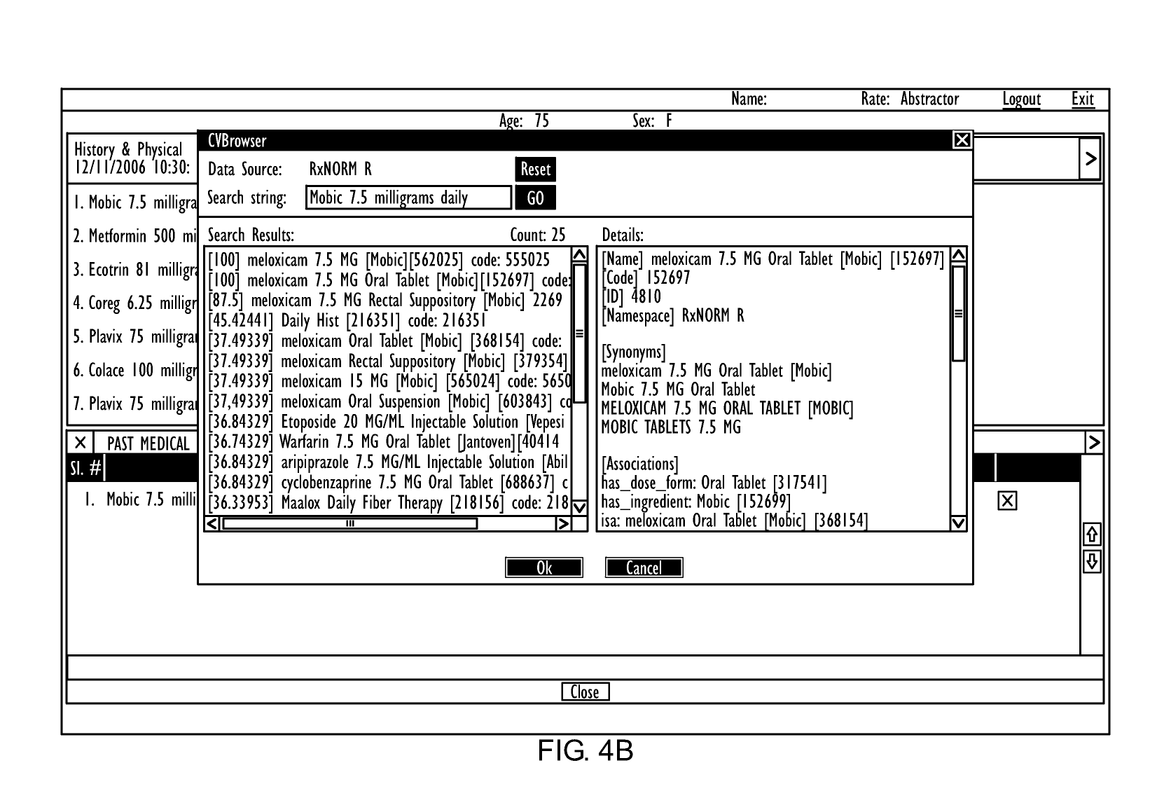

User interface module 117, when executed by controller 112, controls host 110 to present various interactive graphical user interfaces via one or more of host 110, dictation device 111 or terminals 119 and 121 for interacting with user 114, reviewer 118 or validator 120. Exemplary interactive graphic user interfaces provided by user interface module 117 are illustrated in FIGS. 3A-4B, and described below. User interface module 117, after extracting and coding information, may forward the information to workflow engine 119 for further processing.

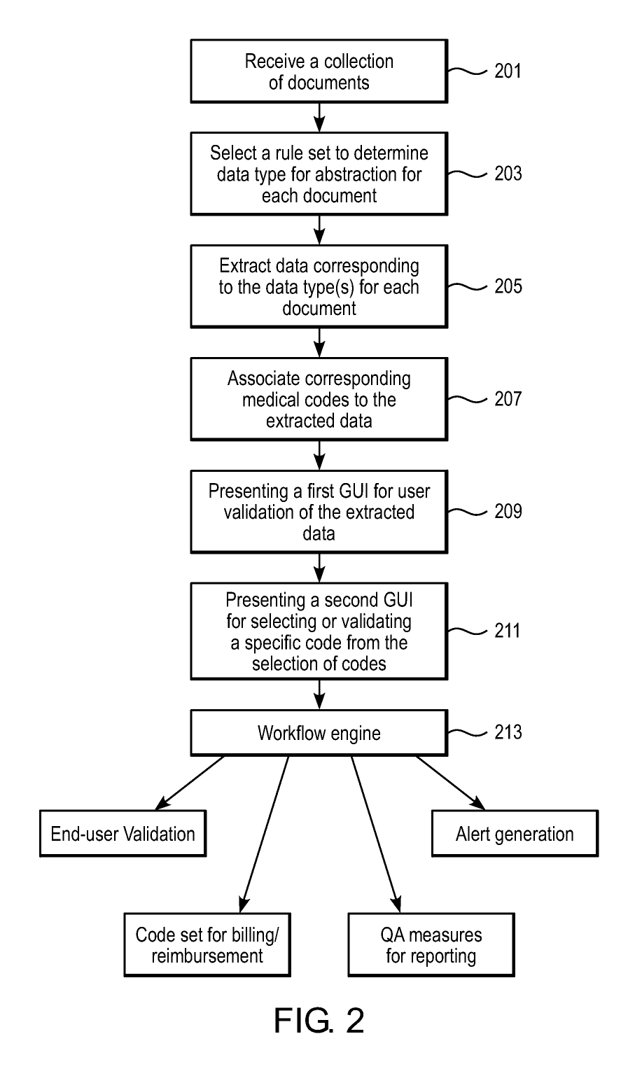

FIG. 2 is a flow chart illustrating an exemplary abstraction and coding process. At step 201, host 110 receives one or more documents from dictation device 111 and/or user 114. For example, host 120 can receive a patient's information from a hospital via a personal computer, including the patient's admission information, progress notes, procedure lists, lab results, history and physical, discharge summary. The received dictations and/or documents may include patient specific information such as the following: names, mailing addresses, ages, dates, telephone numbers, fax numbers, e-mail addresses, social security numbers, medical record numbers, health plan beneficiary numbers, account numbers, certificate/license numbers, license plate numbers, vehicle identifiers, URL addresses, Internet Protocol address numbers, biometric identifiers, photographic images or any other information which may be used to identify an individual. The information may also include non-private information such as, medication lists, allergies, procedure lists, quality measures, problem lists, present on admission diagnoses and guideline adherence information.

After being processed by transcription application 122, host 120 stores the transcribed documents in data storage device 116 and provides the documents to abstraction application 124 along with any received documents that did not require transcription. The one or more documents can be stored together in a patient's chart in data storage device 116.

At step 203, extractor module 113 searches each document for keywords identifying the document type. Once the document type is identified, extractor module 113 selects a rule set from the abstraction rules corresponding to the document type for each document. The abstraction rules specify the information type(s) to extract from a particular type of document. For example, an abstraction rule for a History and Physical may specify the extraction of medical problems. The selected rule set may specify one or more information types for extraction for a document type. Other examples of information that can be extracted from various types of reports include medications, problems, allergies, procedures, laboratory tests or results, quality measures, and adherence to guidelines.

At step 205, extractor module extracts the specified information from the documents based on identified keywords associated with medical problems. The NLP extractor can identify the format of the document and its corresponding section title headers, from the document type. Alternatively, during the transcription of a document, tags may have been inserted to identify individual section headers. For example, referring to FIG. 3A, a History and Physical document contains a “Past Medical History” section title, appearing in portion Al of the screen image. The words within that section may be represented as an unordered collection of words, disregarding grammar and even word order, and can be searched for any words relating to medical problems. Any word found relating to a medical problem is extracted as shown in section A2 of FIG. 3A.

Some extractors can employ a relatively simple set of filtering rules to identify and retrieve desired information. For example, a “History and Physical” document may include one or more of the keywords “CHF,” “Cardiomyopathy,” and “Congestive,” which may be keywords denoting congestive heart failure (i.e., a medical problem). Extractor module 113 can extract congestive heart failure as a medical problem from the History and Physical document that contains any of these keywords. Other extractors may be based upon more complex filters. For instance, an extractor could verify if a guideline for Congestive Heart Failure has been followed. An example of this type of filter is described in greater detail in U.S. patent application Ser. No. 12/265,495, the disclosure of which is incorporated herein in its entirety.

At step 207, linker module 115 evaluates the extracted information to determine an associated code for each extracted item of information. Each abstracted information type is linked to a particular code standard. For example, medical problems are associated with SNOMED codes and medications can be associated with RxNorm codes. Each extracted information item can be mapped to a code using pattern matching and searching algorithms. Linker module 115 searches a database of codes and terminologies, and a match may be found using pattern matching. A search of associated concepts (e.g., synonyms of the extracted data and medications associated with specific medical problems) are also searched to find a pattern match.

Once a match is found, linker module 115 determines the context of the matched data based on evaluating neighboring words or phrases. For example, the phrase “arthritis” may be determined as a match for the extracted data “osteoarthritis.” The context evaluation determines that the phrase “rheumatoid” precedes “arthritis.” Since rheumatoid arthritis describes a different disease from osteoarthritis, it may be concluded that the matched phrase “arthritis” is not a match. When linker module 115 identifies a pattern match and context match, a code associated with the match information may be linked to the extracted information. The codes can each be a unique numeric code (e.g., 57054005 is an associated medical code for the medical problem congestive heart failure).

At step 209, user interface module 117 presents a first interactive graphic user interface to reviewer 118 for validation of the extracted information. Reviewer 118 examines the extracted information and adds any missed extractions and/or corrects inaccurate extractions using the first interactive graphic user interface.

FIGS. 3A-3C illustrate exemplary interactive graphic user interfaces that may be presented to the reviewer for validation. In FIG. 3A, the problems shown in the lower window of the user interface A2 have been extracted from a History and Physical Document, which is shown in the upper window of the user interface Al. Reviewer 118 examines the section shown in the upper window, which illustrates where the information was extracted from, to determine whether the information was extracted correctly. Based on reviewer 118's expertise in the field, (e.g., reviewer 118 may be a doctor, nurse or medical abstractor), the reviewer may manually identify and correct inaccurate or missed extractions.

If an extracted term is not correct, for example, the term pertains to a condition of a patient's relative rather than the patient himself, reviewer 118 can remove the term by selecting on a delete box 301 associated with the extracted term via the interactive graphic user interface provided by user interface module 117. Conversely, if reviewer 118 perceives that a problem identified in the document displayed in the upper window Al has not been extracted, the reviewer can add the problem to the list in the lower window A2 by clicking on “Add Problem” button 302.

In FIG. 3B, the first interactive graphic user interface illustrates medications extracted from a History and Physical Document, and in FIG. 3C, the first interactive graphic user interface illustrates a list of allergies extracted from the History and Physical Document. The lower window A2 of the first user interface includes a column that lists a suggested code for each extracted concept, e.g. medical problem. When a reviewer 118 selects one of the extracted elements shown in section A2 of FIG. 3A, a second interactive graphic user interface is presented at step 211.

FIG. 4A illustrates an exemplary coding process for extracted medical problems and FIG. 4B illustrates an exemplary coding process for extracted medications. The second interactive graphic user interface, illustrated in FIGS. 4A and 4B, is a search screen showing the results of the search performed for coding the extracted information, which may occur automatically after extraction. The forefront window of the second interactive graphic user interface illustrates a search string which corresponds to the selected extracted information (i.e., myocardial infarction). The synonyms and associated concepts of the extracted information are also shown in the forefront window. All the pattern matches are shown in a search results pane 401, and the selected code is shown in a details pane 402. Reviewer 118 examines the details and validates the code, if the code is correct. If the code is incorrect, reviewer 118 may select an appropriate code from the search results in pane 401.

In some exemplary embodiments, the extracted information and/or the coded information can be presented to multiple reviewers in succession. A first reviewer may review the information for accuracy and makes revisions as necessary. Thereafter, the information may be presented to another one of the reviewers to review for quality control. The information can be presented to any number of reviewers in succession.

The generated reports can be submitted to a scrubber application for processing before the report is presented to a reviewer. The scrubber application searches the reports for private information, for example, a list of information items identified by HIPAA as protected health information (PHI), and removes the private information from the documents. One example of a scrubber application is described in U.S. Pat. No. 7,383,183. The scrubbed reports are presented to reviewer 118 for review. The reports can be stored in a queue for subsequent review by the reviewer 118.

Reviewers 118 can download one or more of the reports from the queue to review, or the reviewer can receive the one or more reports after the reports have been scrubbed. Reviewer 118 performs abstraction and/or coding review which may entail verifying the accuracy of the extracted and coded information. Reviewer 118 is typically not privy to patient protected information and thus the reports presented to the reviewer are scrubbed beforehand to remove the patient's personal information.

At any time during the foregoing review processes, if reviewer 118 is not certain about the results or requires further information to perform the validation, the reviewer may submit a query to host 110 for presentment to validator 120 review to inquire about any ambiguities. Validator 120 may send host 110 a response to the query and the response is presented to reviewer 118. Any one of several reviewers in the succession may check with host 110 to see if validator 120 has responded to the request and update the report with the information or complete validation of the information.

At step 213, the extracted information and selected codes or selection of codes may be forwarded to the workflow engine for further processing. In some instance, the reviewer 118 may need to submit a query to the validator to complete workflow processing, as described below. In these instances, the selection of codes is forwarded to workflow engine 119. Workflow engine 119 may include processes including, a end-user validation process, a code set generation process for billing/reimbursement, a quality measures (QA) process for reporting, and an alert generation process.

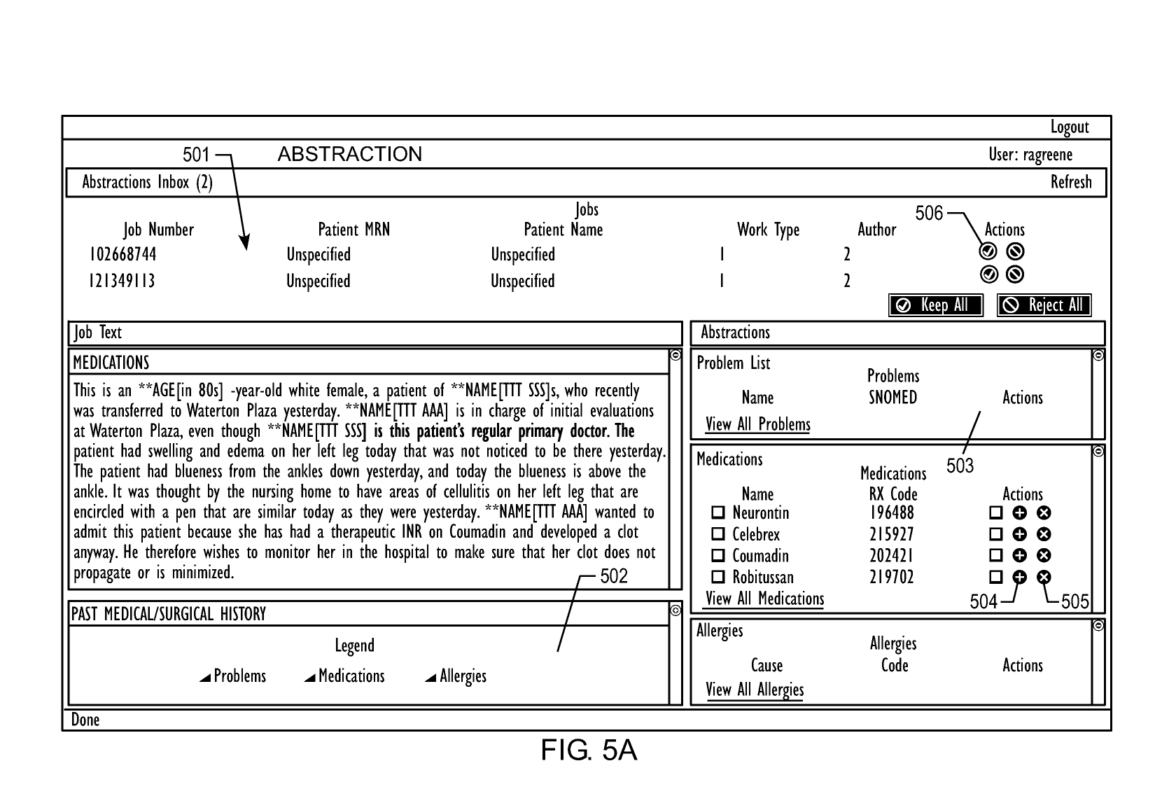

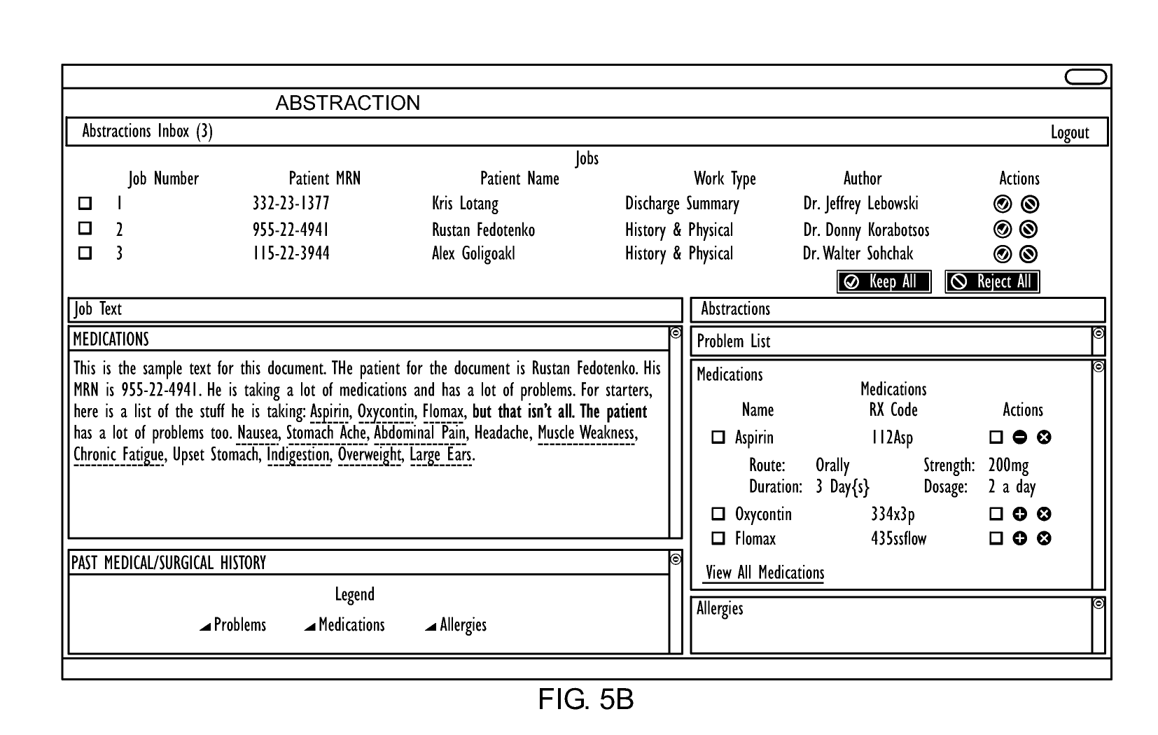

The end-user validation process presents a third interactive graphic user interface, as illustrated in FIGS. 5A and 5B, to validator 120 for end user validation. FIGS. 5A and 5B illustrate end user validation of the information extracted. The third interactive graphic user interface may also illustrate the coded information for end user validation. In FIG. 5A, private information has been omitted (i.e., scrubbed) from the user interface, whereas the view in FIG. 5B includes private information such as, patient names.

Validator 120 reviews the information and validates the information if correct. Referring to FIG. 5A, at the top of the window is a list 501 of abstracted documents that are currently available for validator 120 to review. Text from a selected document, such as the “Medications” section, appears in a lower left pane 502 of the window, and the abstracted concepts appear in a lower right pane 503. In the illustrated example, validator 120 has opened the list of abstracted medications for review. Each listed medication is accompanied by a button 504 that provides validator 120 with the ability to expand the listing to review details about the medication. Referring to FIG. 5B, the listing for “Aspirin” has been expanded to identify the delivery route, strength, duration and dosage for the medication. Each listed medication may also be accompanied by a delete button 505 to remove the listing if validator 120 does not feel that it is correct. The information is validated when validator 120 accepts the information by checking a button 506 in the upper pane to sign the document.

In an exemplary embodiment, host 110 receives an identification and password from validator 120. Host 110 verifies whether the validator is authorized to receive private information using the ID and password. If validator 120 is authorized to receive private information, the information is presented to the validator with the private information, as illustrated in FIG. 5B.

The end-user validation process generates a report of the validated information for storage in storage device 116. The report can be structured in any format such as, the clinical documentation architecture. The report may include a report number and document type. Optionally, the generated report may be submitted to a scrubber application for removing private information before storage in the storage device.

Workflow engine 119 executes the code set for billing and reimbursement process when outputting information for billing and/or reimbursement. Reviewer 118 submits a query to validator 120 to inquire about particular codes needed for billing and reimbursement. Reviewer 118 receives the response and selects the code set from the selection of codes forwarded to the workflow engine as stipulated by validator 120. The process may generate an output (e.g., display or document) for billing and/or reimbursement.

Reviewer 118 may submit a query to validator 120 to inquire about information extracted and coded for processing during the quality assurance measures for the reporting process. Reviewer 118 uses the received information from validator 120 to check quality measures based on the extracted and coded information. The process generates an output for reporting the results of the quality measures.

The alert generation process triggers an alert when pre-defined conditions are met, e.g. absence of a required treatment in a clinical guideline. Reviewer 118 reviews the extracted and coded information to determine if any conditions are satisfied. If so, an alert may be triggered in host 110.

All of the steps above discussed above or illustrated in FIG. 2 may be performed continuously and/or concurrently with a period during which a patient is receiving care at a medical facility, for example, a hospital. As disclosed herein, embodiments and features can be implemented through computer hardware and software. Such embodiments can be implemented in various environments such as networked and computing-based environments with one or more users. The present disclosure, however, is not limited to such examples, and embodiments can be implemented with other platforms and in other environments.

Moreover, while illustrative embodiments have been described herein, further embodiments can include equivalent elements, modifications, omissions, combinations (e.g., of aspects across various embodiments), adaptations and/or alterations as would be appreciated by those in the art based on the present disclosure.

Other embodiments of this disclosure will be apparent to those skilled in the art from consideration of the specification and practice of the embodiments of the embodiments disclosed herein. Further, the steps of the disclosed methods can be modified in various manners, including by reordering steps, executing multiple steps concurrently, and/or inserting or deleting steps, without departing from the principles of the disclosed. It is therefore intended that the specification and embodiments be considered as exemplary only.

What is claimed is:

1. A method of abstracting and coding information by a computer including:
a processor,
an information storage device,
a display device, and
a user-input device,
said method comprising:
extracting by the processor information from a record based on extraction rules stored in the information storage device, said extraction rules corresponding to an identified record type;
determining by the processor a plurality of codes corresponding to the information extracted from the record, said codes belonging to one or more sets of codes stored in the information storage device;
presenting on the display device the correspondence between the extracted information and the codes;
receiving from the user-input device a validation of the correspondence between the extracted information and one of the codes; and
outputting by the processor a report including the validated information and the validated code.

2. The method of claim 1, wherein the record includes text transcribed from a dictation.

3. The method of claim 1, wherein extracting includes, selecting the extraction rules based on keywords in the record.

4. The method of claim 1, wherein extracting includes, identifying information in the record for extraction using natural language processing.

5. The method of claim 1, wherein the codes are determined using natural language processing.

6. The method of claim 1, wherein the sets of codes are standardized code sets including one or more of the following: SNOMED (systemized nomenclature of medicine), RxNorm, ICD 9, ICD 10, LOINC (logical observation identifiers names and codes).

7. The method of claim 1, wherein receiving a validation of the correspondence includes one or more of the following:
receiving a correction of the information extracted from the record by the processor, and
receiving a correction of the codes determined by the processor.

8. The method of claim 7, wherein receiving a correction of one or more of the codes includes:
presenting on the display device a list of the codes associated with the information extracted from the record; and
receiving from the user-input device a selection of a code from the list of the codes.

9. The method of claim 1, wherein, in the event the validated information and the validated code satisfy a condition, the processor generates an alert.

10. The method of claim 1, wherein:
the record is associated with a patient being treated at a medical facility, and
the validated information and the validated code are output before completion of the treatment of the patient by the medical facility.

11. A system for computer-assisted abstraction and coding of information, comprising:
a processor;
a display device;
a user-input device; and
non-transient computer-readable information storage device having program instructions recorded therein, said program instructions when executed by the processor controlling the computer to:
extract by the processor information from a record based on extraction rules stored in the information storage device, said extraction rules corresponding to an identified record type;
determine by the processor a plurality of codes corresponding to the information extracted from the record, said codes belonging to one or more sets of codes stored in the information storage device;
present on the display device the correspondence between the extracted information and the codes;
receive from the user-input device a validation of the correspondence between the extracted information and one of the codes; and
output by the processor a report including the validated information and the validated code.

12. The system of claim 11, wherein the record includes text transcribed from a dictation.

13. The system of claim 11, wherein extracting includes, selecting the extraction rules based on keywords in the record.

14. The system of claim 11, wherein extracting includes, identifying information in the record for extraction using natural language processing.

15. The system of claim 11, wherein the codes are determined using natural language processing.

16. The system of claim 11, wherein the sets of codes are standardized code sets including one or more of the following: SNOMED (systemized nomenclature of medicine), RxNorm, ICD 9, ICD 10, LOINC (logical observation identifiers names and codes).

17. The system of claim 11, wherein receiving a validation of the correspondence includes one or more of the following:
receiving a correction of the information extracted from the record by the processor, and
receiving a correction of the codes determined by the processor.

18. The system of claim 17, wherein receiving a correction of one or more of the codes includes:
presenting on the display device a list of the codes associated with the information extracted from the record; and
receiving from the user-input device a selection of a code from the list of the codes.

19. The system of claim 11, wherein, in the event the validated information and the validated code satisfy a condition, the processor generates an alert.

20. The system of claim 11, wherein:
the record is associated with a patient being treated at a medical facility, and
the validated information and the validated code are output before completion of the treatment of the patient by the medical facility.
